(19) United States
(12) Patent Application Publication
(10) Pub. No.: US 2023/0167348 A1
(43) Pub. Date: Jun. 1, 2023

(54) LOW CURRENT HEAT TRANSFER FLUID FOR SAFER ELECTRICAL APPLICATIONS

(71) Applicant: Valvoline Licensing andIntellectual Property LLC, Lexington, KY (US)

(72) Inventors: Ying Yang, Lexington, KY (US); Samuel Elliott, Lexington, KY (US); Jennifer Jenkins, Lexington, KY (US); David E. Turcotte, Lexington, KY (US); Dale Reid, Lexington, KY (US); Virginia Whittington-Byrd, Winchester, KY (US); Michael King, Catlettsburg, KY (US)

(21) Appl. No.: 17/457,137

(22) Filed: Dec. 1, 2021

(51) Int. Cl. C09K 5/20; H01M 10/613; H01M 10/625; H01M 10/6567

(52) U.S. Cl. CPC C09K 5/20; H01M 10/613; H01M 10/625; H01M 10/6567; H01M 2220/20

(57) ABSTRACT

A heat transfer fluid for electrical applications includes water soluble glycol 5 wt. % to 98 wt. %, demineralized water 0 wt. % to 95 wt. %, and a total dissolved solid inorganic additive content in the heat transfer fluid of 0.1 wt. % to 2 wt. %. The electrical conductivity of the heat transfer fluid is 100 μS/cm to 5000 μS/cm.

### RELATED TECHNOLOGY

The present disclosure relates to heat transfer fluids, and more specifically relates to reduced solids heat transfer fluids that limit current flow inherently for safer modern energy device applications.

### BACKGROUND

Energy devices (e.g., devices for energy storage, transfer, and generation, such as wind turbines, solar cell systems, lithium ion batteries, charging ports, fuel cells, capacitors, etc.) generating heat require cooling. Energy devices may also require heating in cold weather to function efficiently. Conventionally, a heat transfer fluid is circulated through a cooling system, in close proximity but electrically isolated from the energized circuitry, to help maintaining the operating temperature range and proper function of the energy device. In response to growing demands of high-performance energy dense devices (e.g., energy devices in electric vehicles, power storage, and renewable energy applications like solar cells and wind turbines), challenges are faced in engineering the heat transfer fluids to extend the energy devices' life and protect other components in the electrical systems powered by the energy devices. High performance heat transfer fluids are needed for normal operational conditions where heat transfer fluids are electrically isolated from the rest of the energy device. High performance heat transfer fluids are also needed for scenarios where the heat transfer fluids leak onto energized electrical components (e.g., due to accidental damage, seal failure, or component failure). In the latter case, it is important to minimize current flow to prevent or limit unintended current paths and heating, which can lead to increasing damage, melting, short circuits, and catastrophic fire.

### SUMMARY

In one embodiment, a heat transfer fluid for electrical applications includes water soluble glycol 5% by weight (wt. %) to 98 wt. %, demineralized water 0 wt. % to 95 wt. %, and a total dissolved solid inorganic additive content in the heat transfer fluid of 0.1 wt. % to 2 wt. %. An electrical conductivity of the heat transfer fluid is 100 micro-siemens per centimeter (μS/cm) to 4000 μS/cm.

In one embodiment, an energy storage system includes a cooling system configured to cool components of the energy storage system. The cooling system includes a heat transfer fluid that includes water soluble glycol 5 wt. % to 98 wt. %, demineralized water 0 wt. % to 95 wt. %, and a total dissolved solid inorganic additive content in the heat transfer fluid of 0.1 wt. % to 2 wt. %. An electrical conductivity of the heat transfer fluid is 100 μLS/cm to 4000 μS/cm.

In another embodiment, a method of cooling an energy storage system includes obtaining a cooling system for the energy storage system. The method includes disposing a heat transfer fluid in the cooling system. The heat transfer fluid includes water soluble glycol 5 wt. % to 98 wt. %, demineralized water 0 wt. % to 95 wt. %, and a total dissolved solid inorganic additive content in the heat transfer fluid of 0.1 wt. % to 2 wt. %. An electrical conductivity of the heat transfer fluid is 100 μLS/cm to 4000 μS/cm. The method also includes operating the cooling system to cool components of the energy system.

### BRIEF DESCRIPTION OF THE DRAWINGS

FIG. 1 shows an example test system for evaluating discharge current of a heat transfer fluid when it contacts energized circuit;

FIG. 2 shows a comparison between current flow test results of heat transfer fluids disclosed herein using the test system of FIG. 1 with aluminum electrodes;

FIG. 3 shows a comparison between current flow test results of heat transfer fluids disclosed herein using the test system of FIG. 1 with copper electrodes;

FIG. 4 shows an example of significant deposit formation on a charged electrical connector immersed in a high solids and high electrical conductivity heat transfer fluid;

FIG. 5 shows an example of minimal deposit formation on a charged electrical connector immersed in a low solids and high electrical conductivity heat transfer fluid;

FIG. 6 shows an example charged wire test result of charged aluminum connectors immersed in a low solids (at 1 wt. % undiluted) and high electrical conductivity (3000 μS/cm) heat transfer fluid disclosed herein;

FIG. 7 shows an example charged wire test result of charged aluminum connectors immersed in a conventional/traditional heat transfer fluid with high solids (at 5 wt. % undiluted) and high electrical conductivity (3000 μS/cm);

FIG. 8 shows an example charged wire test result of charged nickel plated brass connectors immersed in a low solid and high electrical conductivity heat transfer fluid disclosed herein;

FIG. 9 shows an example charged wire test result of charged nickel plated brass connectors immersed in a conventional/traditional heat transfer fluid with high solid additives (5 wt. %) and high electrical conductivity (3000 μS/cm);

FIG. 10 shows an example cooling system including the low solids and low electrical conductivity heat transfer fluids disclosed herein for cooling an energy storage system; and

FIG. 11 shows an example method of cooling an energy storage system using the low solids and low electrical conductivity heat transfer fluids disclosed herein.

### DETAILED DESCRIPTION

Most electrical energy generation, transfer and storage systems (e.g., solar cells, wind turbines, generators, battery systems, fuel cell systems, capacitor systems, etc.) need heat transfer fluids (e.g., cooling fluids, coolants) for thermal management purposes. Low electrical conductivity is widely considered critical for the heat transfer fluids used in many energy storage systems from a safety and performance point of view. Leak of heat transfer fluids from an electrically isolated and typically an indirect cooling system, often leads to unintended current flow and heat generation and deposit/corrosion products tend to build up around electrically charged parts. These leaking events can readily lead to shorts, arcing, and/or fire/ignition in the system. For example, when heat transfer fluids seep onto sections of electrical systems with exposed terminals or connectors during a sealing failure, depending on the metals/materials, various corrosion products/additives could build up under current flow from electrode areas (e.g., cathode areas and especially anode areas) and cause short circuits, arcing, or ignition of the system due to unintended current paths.

The conventional approach taken by equipment manufacturers and heat transfer fluid suppliers to address the current flow (e.g., intended current flow due to intended contact and unintended current due to leaking heat transfer fluids) has been formulating the heat transfer fluids to reduce the electrical conductivity. However, the heat transfer fluids formulated following the conventional approach may sacrifice on the range of metal corrosion protection. Furthermore, the conventional heat transfer fluids may have several drawbacks or limitations. For example, the use of conventional heat transfer fluids on metals may be limited to aluminum and yellow metals. Specifically, conventional heat transfer fluids typically have a lower than pH=7 operational ending pH value, hence they are not suitable for use on ferrous metals. For example, the expected conductivity range of conventional heat transfer fluids (formulations including water glycol for heat transfer and freeze protection) used in fuel cell applications is about 5 μS/cm to no greater than 50 μS/cm. However, these heat transfer fluids due to their inherent metal compatibility limitations, are not suitable or would not function for applications in internal combustion engines, hybrid electric vehicles, battery powered electrical vehicle applications.

Unlike the conventional dielectric cooling approach, the present disclosure is directed to limiting the solid contents of the electrically indirect heat transfer fluids. The low solids heat transfer fluids disclosed herein demonstrate surprisingly better results (than heat transfer fluids primarily formulated to achieve reduced electrical conductivity) in terms of managing unintended current flow, heat generation, solid deposit formation, and improved safety if leaks occur. The heat transfer fluids disclosed herein are formulated to greatly reduce or eliminate solid additives.

In some embodiments, the heat transfer fluids disclosed herein are adopted with liquid components in place of solid additives at similar concentrations. These heat transfer fluid formulations are capable of providing alkaline buffering and protecting all types of metals in a cooling system, and show surprisingly better results in effectively limiting current flow and heating, and reducing deposit formation around electrodes (cathodes and especially anodes).

The adoption of liquid additives in heat transfer fluids also contributes to surprisingly beneficial effects on safety. The typical electrical conductivity of an internal combustion engine coolant is about 3000 μS/cm, which may lead to catastrophic failures if leaking onto energized electrical components. High current and/or heat generation often lead to catastrophic failures, like melting, unintended current flow, and ignition. The low solids heat transfer fluids disclosed herein (e.g., low or significantly lower solid contents as the solid additives are replaced by liquid additives) are formulated to provide better electrical current limitation and reduced heat generation in order to reduce the safety risk in an leaking event.

The heat transfer fluids disclosed herein are formulated to have a reduced electrical conductivity, e.g., 100 μS/cm to 5000 μS/cm, 100 μS/cm to 4000 μS/cm, 100 μS/cm to 3000 μS/cm, 100 μS/cm to 2000 μS/cm, 100 μS/cm to 1000 μS/cm, or 100 μS/cm to 500 μS/cm, 200 μS/cm to 5000 μS/cm, 250 μs/cm to 5000 μS/cm, 300 μs/cm to 5000 μS/cm, 400 μs/cm to 5000 μs/cm, 500 μS/cm to 5000 μS/cm, 500 μS/cm to 3000 μS/cm, 1000 μS/cm to 3000 μS/cm, 1250 μS/cm to 3500 μS/cm, or any individual integer found within any of these ranges, e.g. 1250 μs/cm or 3000 μS/cm, or 3000 μS/cm±100 μS/cm. Preferably the electrical conductivity of the heat transfer fluids described herein are greater than 50 μS/cm, and more preferably greater than 55 μS/cm, or greater than 60 μS/cm, or greater than 100 μS/cm. The electrical conductivity of the heat transfer fluids disclosed herein is tuned to offer sufficient corrosion protection for components typically seen in energy devices (e.g., components made of metal alloys, ferrous metals, aluminum, yellow metals, solder, stainless steels, etc.) and still satisfy safety measures for use in an electrical indirectly cooled electrical system during normal operation and sealing failure.

The heat transfer fluids disclosed herein are formulated to include additives to help stop or significantly reduce electrode corrosion and corrosion layer build up on metal surfaces. For example, the heat transfer fluids disclosed herein are formulated to have a low current response in a fluid leaking event to slow down the heat generation and corrosion reaction product formation and reduce safety risk if the electrical system is unintentionally wetted with the heat transfer fluids.

The heat transfer fluids disclosed herein may be used in any suitable mobile or stationary energy storage devices or systems, e.g., batteries, rechargeable batteries, lithium ion batteries, fuel cells, capacitors, etc. in airplanes, helicopters, jet skis, snow mobiles, boats, automobiles, electric vehicles, electric charging stations, renewable energy applications, power generation/storage applications, etc.

Formulation of the Heat Transfer Fluids

The heat transfer fluids disclosed herein may be formulated based on many solvents and mixtures of solvents to offer varied thermal conductivity and dielectric properties. In some embodiments, in addition to the correction protection properties, the heat transfer fluids disclosed herein are formulated to offer freeze protection. The heat transfer fluids disclosed herein may be formulated based on aqueous compositions or nonaqueous compositions. In some embodiments, the nonaqueous compositions may have a lower heat transfer efficiency compared to the aqueous compositions, and the nonaqueous compositions may include low electrical conductivity and good dielectric materials.

Table 1 shows examples of several heat transfer candidates for use in heat transfer fluids. In particular, heat transfer fluids including glycol and water glycol may have several advantages for use in indirect electrical system cooling applications, e.g., advantages including higher thermal conductivity, absence of flash point, low viscosity, and superior freeze protection, etc.

TABLE 1

| | | | | | Kinematic | |
|---|---|---|---|---|---|---|
| | Thermal | Electrical | Heat | Density | Viscosity | |
| | Conductivity* | Conductivity* | Capacity* | at 20° C. | at 25° C. | Flash Point |
| Description | (W/m · K) | (S/m), max | (J/g · ° C.) | (g/cm³) | (cSt) | (° C.), min |
| Water/ethylene | 0.39 | 2 × 10⁻⁴ | 3.4 | 1.07 | 4 | None |
| glycol | | | | | | |
| Brine | 0.52 | 1 × 10⁻¹ | 2.8 | 1.28 | 1.7 | None |
| Glycol ether | 0.165 | 1 × 10⁻⁴ | 2 | 1.03 | 7 | 125 |
| Base oil | 0.135 | 1 × 10⁻⁹ | 2 | 0.8 | 9 | 145 |
| Air | 0.026 | 1 × 10⁻¹⁵ | 1 | 0.0012 | 15 | None |

*properties at room temperature

Undesirable inorganic solid additives used in traditional high solids engine coolants are based on glycol and water including buffers like borax and phosphates up to several weight percent, which contributes significantly to high solid contents (the amount of total dissolved solids). Soluble solid corrosion inhibiting organic acids both linear and aromatic, mono, di and poly hydroxy species like benzoate, adipic acid, sebacic acid, dodecanedioic acid, para t-butyl benzoate and others, also contribute to high solid contents. The organic acids are typically neutralized with similar amounts of solid hydroxides like potassium hydroxide (KOH) and sodium hydroxide (NaOH). Solid inorganics such as nitrate, nitrite, molybdates, vanadates, tungstates and other inorganics also contribute to high solid contents. The heat transfer fluids disclosed herein are formulated such that the inorganic solids are limited and minimized to the extent possible given the application. Furthermore, solids may be replaced with liquid organic components at similar concentrations to achieve better benefits.

Table 2 shows an example Formulation I of a traditional/conventional heat transfer fluid having a high solid content and a high electrical conductivity. The solid content, e.g., the total dissolved solid by weight, is about 5 weight percent (wt. %), and the electrical conductivity is about 3000 μS/cm around room temperature, e.g., 25 degree Celsius (° C.). Specifically, sodium tetraborate penta hydrate, sodium benzoate, sodium nitrite, sodium nitrate, benzotriazole, PVP, and stabilized silicate solution in Formulation I together contribute to about 5 wt. % of the total dissolved solids.

TABLE 2

| | Weight percent |
|---|---|
| High Inorganic Solids Example Formulation I | (wt. %) |
| Ethylene glycol (antifreeze grade) | 94 |
| Sodium tetraborate penta hydrate** | 1.5 |
| Sodium benzoate** | 2.6 |
| Sodium nitrite** | 0.4 |
| Sodium nitrate** | 0.3 |
| Benzotriazole** | 0.1 |
| Polyvinylpyrrolidone (PVP)** | 0.2 |
| Stabilized silicate solution**, 50% | 0.25-0.4 |
| Demineralized water | 0.5 |
| Dyes, defoamers, scale inhibitors and bitterants | Balance |
| Total | 100 |

**indicates compound that contributes to the total dissolved solids.

As discussed in the present disclosure, it is desirable to significantly reduce or eliminate the amount of inorganic solid contents used in the coolant/heat transfer fluids to reduce salt formation when dried or under voltage/current exposure. The heat transfer fluids disclosed herein are formulated to include water soluble glycol of 0 wt. % to 100 wt. %, 5 wt. % to 100 wt. %, 5 wt. % to 98 wt. %, 20 wt. % to 100 wt. %, 30 wt. % to 100 wt. %, 40 wt. % to 100 wt. %, or 50 wt. %, and demineralized water of 0 wt. % to 100 wt. %, 0 wt. % to 95 wt. %, 0 wt. % to 80 wt. %, 0 wt. % to 70 wt. %, 0 wt. % to 60 wt. %, or 50 wt. %, 200 μS/cm to 5000 μS/cm, 250 μS/cm to 5000 μS/cm, 300 μS/cm to 5000 μS/cm, 400 μS/cm to 5000 μS/cm, 500 μS/cm to 5000 μS/cm, 500 μS/cm to 3000 μS/cm, 1000 μS/cm to 3000 μS/cm, 1250 μS/cm to 3500 μS/cm, or any individual integer found within any of these ranges, e.g. 1250 μS/cm or 3000 μS/cm, or 3000 μS/cm±100 μS/cm. Preferably the electrical conductivity of the heat transfer fluids described herein are greater than 50 μS/cm, and more preferably greater than 55 μS/cm, or greater than 60 μS/cm, or greater than 100 μS/cm. The total dissolved solid inorganic additive content in the heat transfer fluids disclosed herein is between 0.01 wt. % and 3 wt. %, 0.1 wt. % and 2 wt. %, 0.1 wt. % and 1.8 wt. %, 0.1 wt. % and 1.5 wt. %, or 0.1 wt. % and 1.2 wt. %. The electrical conductivity is between 100 μS/cm to 5000 μS/cm, 100 μS/cm to 4000 μS/cm, 100 μS/cm to 3000 μS/cm, 100 μS/cm to 2000 μS/cm, 100 μS/cm to 1000 μS/cm, or 100 μS/cm to 500 μS/cm.

In some embodiments, the water soluble glycol may be an antifreeze grade ethylene glycol of 30 wt. % to 70 wt. %, 40 wt. % to 60 wt. %, or 50%, the demineralized water may be 30 wt. % to 70 wt. %, 40 wt. % to 60 wt. %, or 50%, and the heat transfer fluids may further include azole compound(s) (e.g., benzotriazole, tolyltriazole, or similar heterocyclic N containing ringed compounds) of 0.01 wt. % and 10 wt. %, 0.01 wt. % and 5 wt. %, or 0.01 wt. % and 3 wt. %, or 0.01 wt. % and 3 wt. %, an alkaline neutralizing agent 0 wt. % to 10 wt. %, 2 wt. % to 10 wt. %, 4 wt. % to 8 wt. %, or about 7 wt. %, and liquid organic additives 0 wt. % to 30 wt. %, 0 wt. % to 20 wt. %, 0 wt. % to 10 wt. %, 0 wt. % to 5 wt. %, or 0 wt. % to 3 wt. %.

In some embodiments, the alkalinity of the heat transfer fluid is provided by alkali metal hydroxides and/or amines like triethanolamine (TEA).

In some embodiments, the heat transfer fluids may include water soluble alcohols.

In some embodiments, the heat transfer fluids may include base oil, silicone oil, glycol ethers, or a combination thereof.

In some embodiments, the heat transfer fluids may include liquid organic acids and liquid amines formulated to neutralize the liquid organic acids. The liquid organic acids may include isononanoic acid, 2-ethylhexanoic acid, or a combination thereof, and the liquid amines may include triethanolamine, related liquid compound, or a combination thereof.

In some embodiments, the heat transfer fluids are formulated for use in a cooling system of an electrical vehicle.

Examples of heat transfer fluid formulations having low solid content and/or low electrical conductivity are shown in Tables 3-6 below.

Table 3 shows an example heat transfer fluid Formulation II with the solid content about 1.2 wt. % and the electrical conductivity about 3000 μS/cm around room temperature. Specifically, potassium hydroxide, sodium molybdate (dihydrate) crystals, and sodium tolyltriazole solid together contribute to about 1.2 wt. % of the total dissolved solids in a low solids internal combustion engine coolant. Upon 50% dilution with demineralized water, the solids can be further reduced from about 1.2 wt. % to 0.6 wt. %. In some embodiments, other branched, liquid organic acids can be used to replace the 2-ethylhexanoic acid in Formulation II.

TABLE 3

| | Weight percent |
|---|---|
| Low Inorganic Soilds 2EHA Example Formulation II | (wt. %) |
| Ethylene glycol (antifreeze grade) | 95 |
| Potassium hydroxide** | 0.85 |
| 2-Ethylhexanoic acid liquid | 3.00 |
| Sodium molybdate crystals** | 0.1 |
| Sodium tolyltriazole solid** | 0.25 |
| Dyes, water, defoamers, scale inhibitors, bitterant | Balance |
| Total | 100 |

**indicates compound that contributes to the total dissolved solids.

Table 4 shows an example heat transfer fluid Formulation III with the solid content about 1.2 wt. % and the electrical conductivity about 3000 μS/cm around room temperature. Specifically, potassium hydroxide, sodium molybdate (dihydrate) crystals, and sodium tolyltriazole solid together contribute to about 1.2 wt. % of the total dissolved solids in a low solids internal combustion engine coolant. Upon 50% dilution with demineralized water, the solids can be further reduced from about 1.2 wt. % to 0.6 wt. %.

TABLE 4

| | Weight percent |
|---|---|
| Low Inorganic Solids INA Example Formulation III | (wt. %) |
| Ethylene glycol (antifreeze grade) | 95 |
| Potassium hydroxide** | 0.85 |
| Iso-nonanoic Acid (INA) | 3.00 |
| Sodium molybdate crystals** | 0.1 |
| Sodium tolyltriazole solid** | 0.25 |
| Dyes, water, defoamers, scale inhibitors, bitterant | Balance |
| Total | 100 |

**indicates compound that contributes to the total dissolved solids.

In order to reduce both the solid content and electrical conductivity of heat transfer fluids, desirable additives that may be added are protective liquid organic acids which often include branched hydrocarbon chain structures like isononanoic acid and 2-ethylhexanoic acid. In Formulation III, isononanoic acid (INA) is used instead of 2-ethylhexanoic acid. In some embodiments, a mixture of isononanoic acid and 2-ethyl hexanoic acid may be used instead of 2-ethyl hexanoic acid.

In some embodiments, instead of solid or hydroxides like potassium hydroxide and sodium hydroxide, liquid amines like triethanolamine (TEA) may be used to neutralize liquid organic acids to produce alkaline solutions with excellent alkalinity, buffering and corrosion inhibition properties. TEA and related liquid compounds may be used to replace hydroxides to reduce the amount of dissolved solids in heat transfer fluids. In some embodiments, potassium hydroxide in Formulation III may be replaced with TEA and related liquid compounds or replaced with a mixture of TEA and related liquid compounds and alkali metal hydroxide.

Table 5 shows an example heat transfer fluid Formulation IV with the solid content below 1 wt. % (about 0.65 wt. %) and the electrical conductivity about 1500 μS/cm around room temperature. Specifically, tolyltriazole solid and stabilized-silicate solution together contribute to about 0.65 wt. % of the total dissolved solids in a low solids internal combustion engine coolant.

TABLE 5

| Lowest Inorganic Solids Example-New Liquid | Weight percent |
|---|---|
| Amine Buffered Formulation IV | (wt. %) |
| Ethylene glycol (antifreeze grade) | 88 |
| 2-Ethyl-hexanonic organic acid liquid 100% | 3 |
| Triethanol-amine 99% | 7 |
| Tolyltriazole solid** | 0.3 |
| Stabilized-silicate solution**, 50% | 0.35-0.7 |
| Dyes, defoamer water | Balance |
| Total | 100 |

**indicates compound that contributes to the total dissolved solids.

By eliminating KOH, Formulation IV yields minimal deposits and good results in the current dissipation test, and offers corrosion protection to all types of cooling system metals including aluminum, ferrous metals, and yellow metals. Formulation IV also offers superior buffering with a reserved alkalinity of 35 mls per ASTM D1121.

Table 6 shows an example Formulation V of a traditional/conventional a dielectric fluid used for direct electrical contact on electrical components (e.g., fuel cell application), with very low solid content (0.1 wt. %) and very low electrical conductivity (5 μS/cm around room temperature). Specifically, benzotriazole in Formulation V contributes to about 0.1 wt. % of the total dissolved solids.

TABLE 6

| Low Inorganic Solids, Low Conductivity | Weight percent |
|---|---|
| Example Formulation V | (wt. %) |
| Ethylene glycol (antifreeze grade) | 51.6 |
| Demineralized Water | 48.2 |
| Benzotriazole Solid** | 0.1 |
| Ortho silicate Liquid | 0.1 |

**indicates compound that contributes to the total dissolved solids.

Both the solid content and electrical conductivity of Formulation V are significantly lower than that of Formulations I, II, III, and IV. However, Formulation V is not suitable for many applications for several reasons. First, the in order to achieve such low electrical conductivity (e.g., lower than 50 μS/cm, about 5 μS/cm), only very limited additive(s) can be used. The highly limited additive content precludes metallic compatibility and protective performance in many applications broadly. For example, Formulation V would not be suitable for use in systems containing metal components (e.g., internal combustion engine, battery system, etc.) due to the compromised metallic compatibility and protective performance. Second, the purity requirement is stringent in order to achieve such low solid content (e.g., 0.1 wt. %). The stringent purity requirement making Formulation V difficult to manufacture, and a filtration process during use may be required to maintain the low conductivity.

In some embodiments, the low solids heat transfer fluids disclosed herein may include water, water soluble alcohols (e.g., ethanol, propanol, methanol, etc.), water soluble glycols (e.g., ethylene glycol, propylene glycol, high molecular weight glycols, etc.), anhydrous polyglycols, base oils, silicone oils, and glycol ethers. For example, all or a portion of the ethylene glycol (antifreeze grade) in the formulations shown in Tables 3, 4, and 5 may be replaced by water soluble alcohols (e.g., ethanol, propanol, methanol, etc.), propylene glycol, high molecular weight glycols, anhydrous polyglycols, glycol ethers, or a combination thereof. For example, all or a portion of the liquid silicate in the formulation shown in Table 5 may be replaced by base oils, silicone oils, or a combination thereof. In some embodiments, the dye may be omitted from the formulations shown in Tables 3, 4, and 5.

Test Results

Formulations shown in Tables 3, 4, and 5 are formulated to pass ASTM D3306 tests that define requirements for broad use as EV and ICE heat transfer fluids. In addition, the formulations shown in Tables 3, 4, and 5 are formulated to provide improved performance by reducing and significantly limiting deposits on energized components.

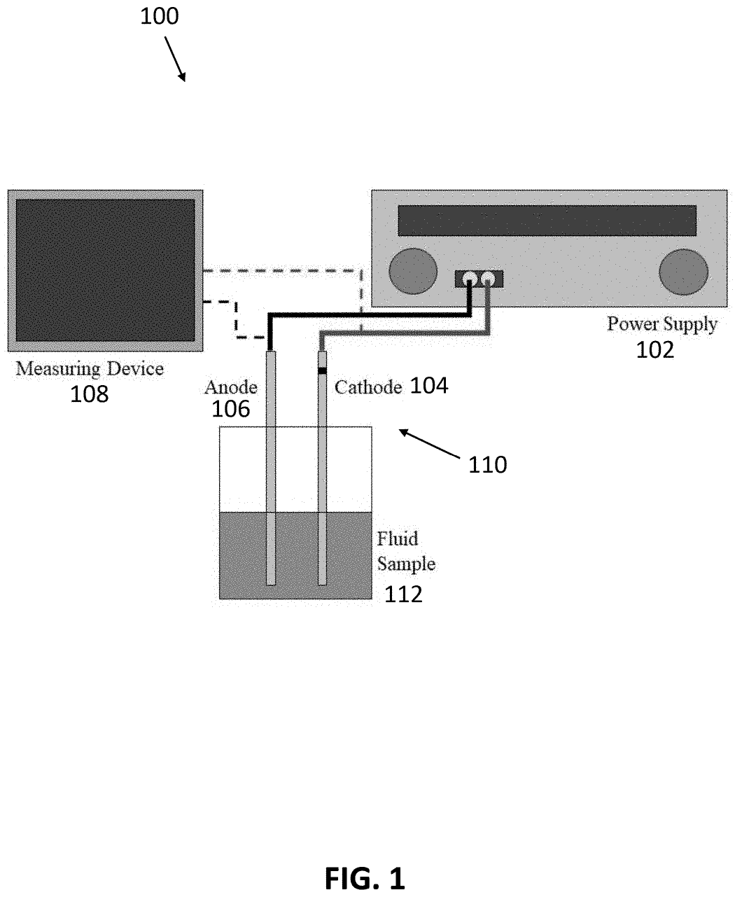

FIG. 1 shows an example test system 100 for evaluating the discharge current flow when the test liquid (e.g., heat transfer fluids) contacts energized circuits. The test system 100 includes a power supply 102, a cathode 104 and an anode 106 coupled to the power supply 102. The test system 100 includes a measuring device 108 coupled to the cathode 104 and anode 106. The measuring device 108 is capable of measuring a discharge current flow through a test circuit 110, e.g., the test circuit formed when the cathode 104 and anode 106 are at least partially immersed in a fluid sample 112 (e.g., the heat transfer fluids) and the power supply 102 is turned on. The power supply 102 may be a 90-volt (V) power supply and capable of supplying up to 10 amperes (A) of current per minute or as needed. The cathode 104 and anode 106 may be made of any suitable electrically conductive materials, e.g., aluminum electrodes, copper electrodes.

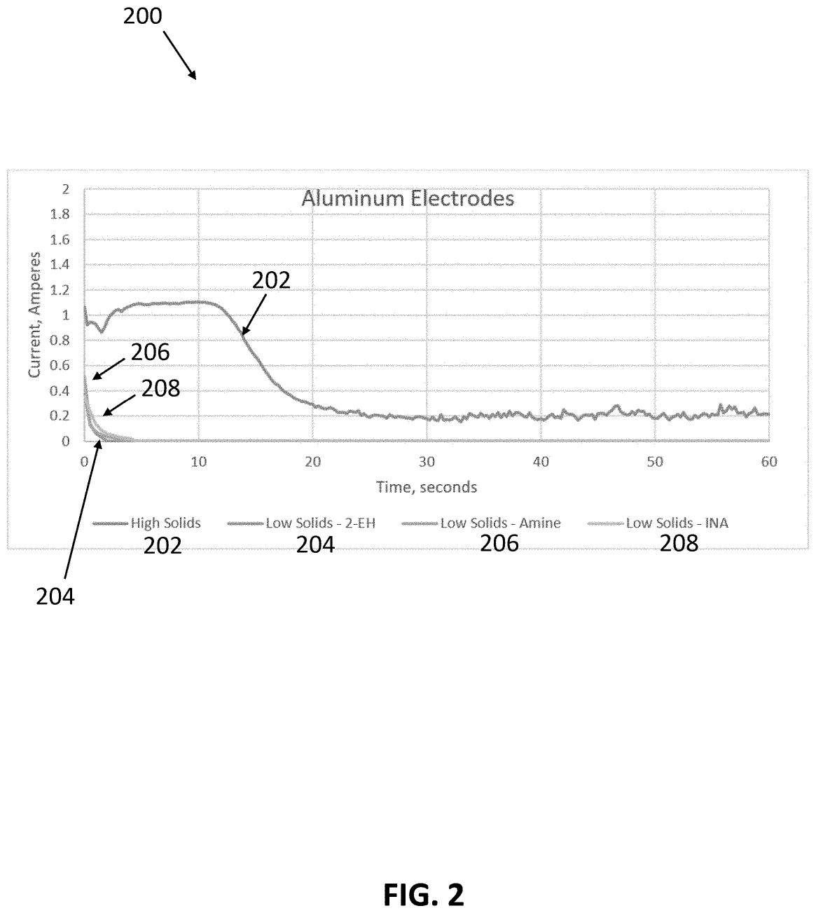

FIG. 2 show a comparison between the current flow test results of the heat transfer fluid formulations shown in Tables 2, 3, 4, and 5. In a current v.s. time plot 200, the electrical currents are measured using the test system 100 with aluminum electrodes and the power supply at 90 V. Series 202, 204, 206, and 208 correspond to the measured electrical currents when the aluminum electrodes are immersed in Formulations I, II, IV, and III, respectively.

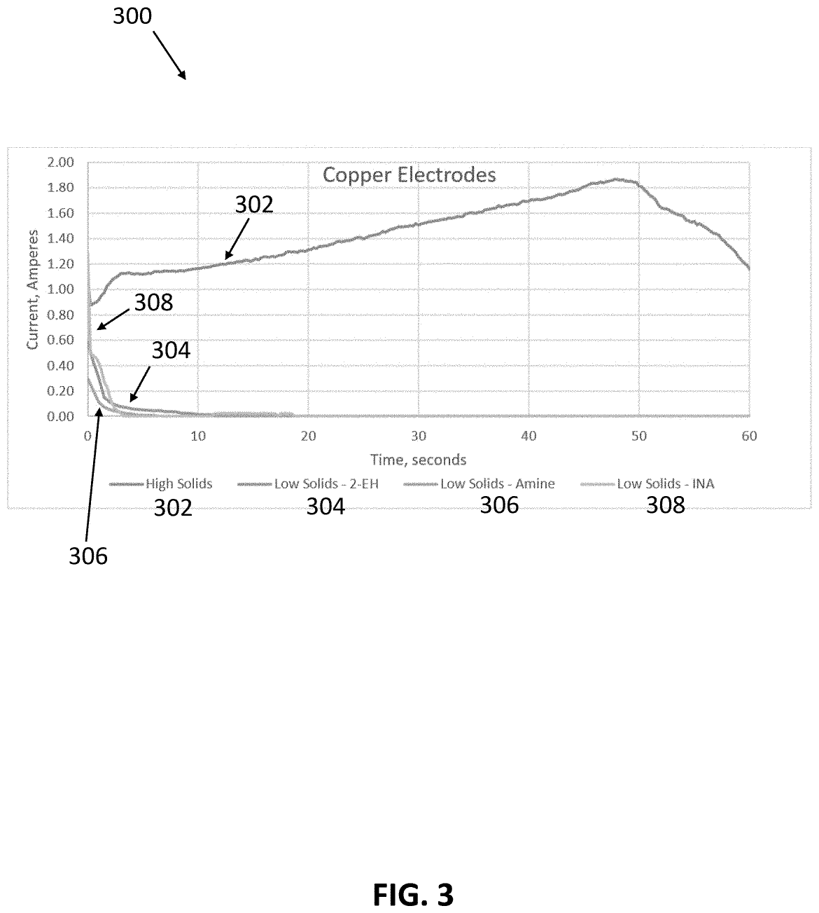

FIG. 3 show a comparison between the current flow test results of the heat transfer fluid formulations shown in Tables 2, 3, 4, and 5 when copper electrodes are used instead of aluminum electrodes. In a current v.s. time plot 300, the electrical currents are measured using the test system 100 with copper electrodes and the power supply at 90 V. Series 302, 304, 306, and 308 correspond to the measured electrical currents when the copper electrodes are immersed in Formulations I, II, IV, and III, respectively.

In both electrode examples shown in FIGS. 2 and 3 (e.g., aluminum and copper electrodes), much higher current flows are measured for the heat transfer fluids of higher solid contents, Formulation I in particular. In addition, higher heat generation and more deposit formation are also observed for the heat transfer fluids of higher solid contents. Thus, it is beneficial to formulate the heat transfer fluid formulations shown in Tables 3, 4, and 5 to have relatively low solid contents (e.g., 0.5 wt. % to 2 wt. %) to limit heat generation and deposit formation.

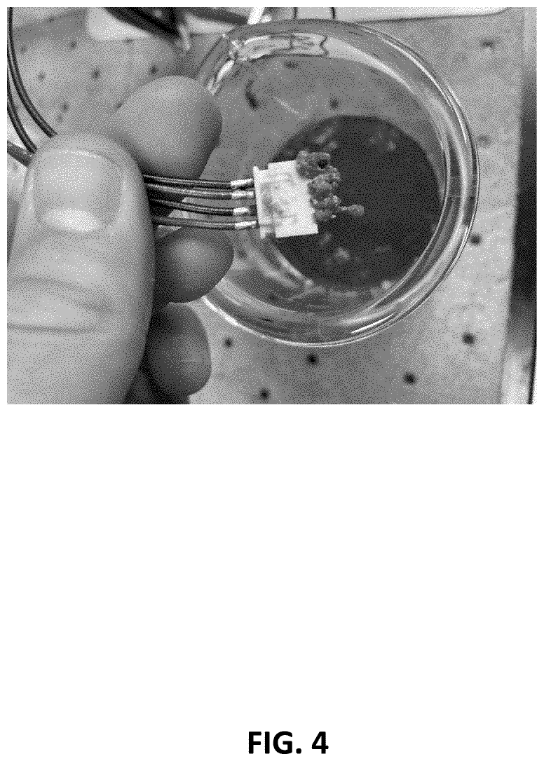

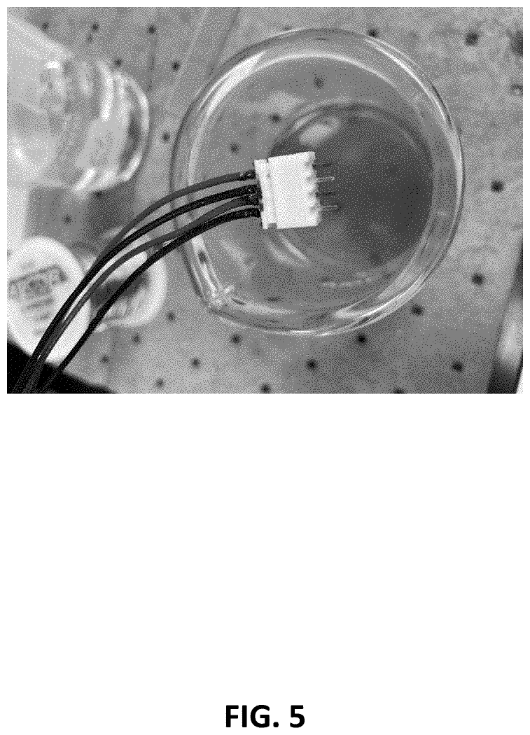

As shown in FIG. 4, there is significant deposit formation on a charged electrical connector immersed in a high solids and high electrical conductivity heat transfer fluid, e.g., Formulation I. To the contrary, as shown in FIG. 5, the deposit formation is minimal or negligible on a charged electrical connector immersed in a low solids and high electrical conductivity heat transfer fluid, e.g., Formulation II.

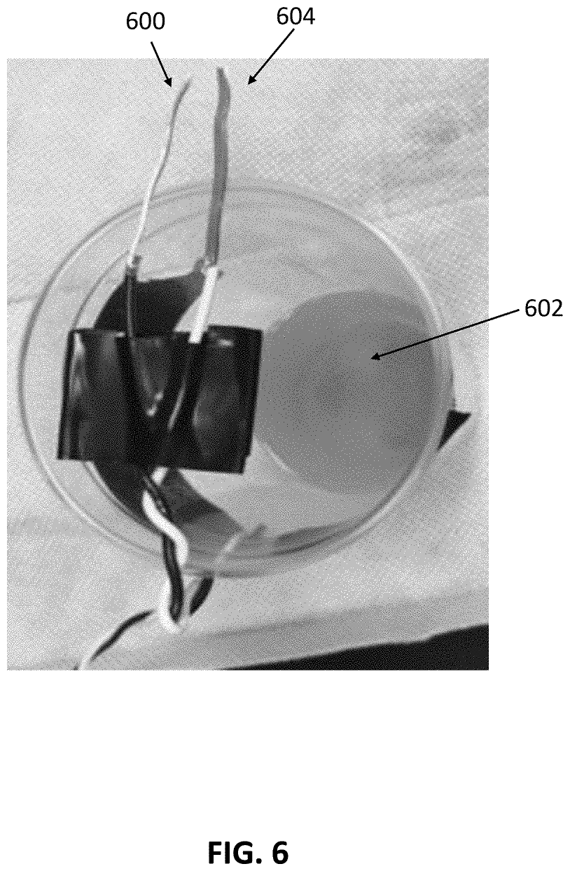

FIGS. 6-9 show comparisons between the charged wire test results of conventional/traditional heat transfer fluids and the low solids heat transfer fluids disclosed herein.

FIG. 6 shows an example charged wire test result of charged connectors 600, e.g., aluminum connectors, immersed in a low solid and low electrical conductivity heat transfer fluid 602 disclosed herein, e.g., formulation shown in Table 5. There is substantially free of corrosion/salt deposits 604 on the connectors 600.

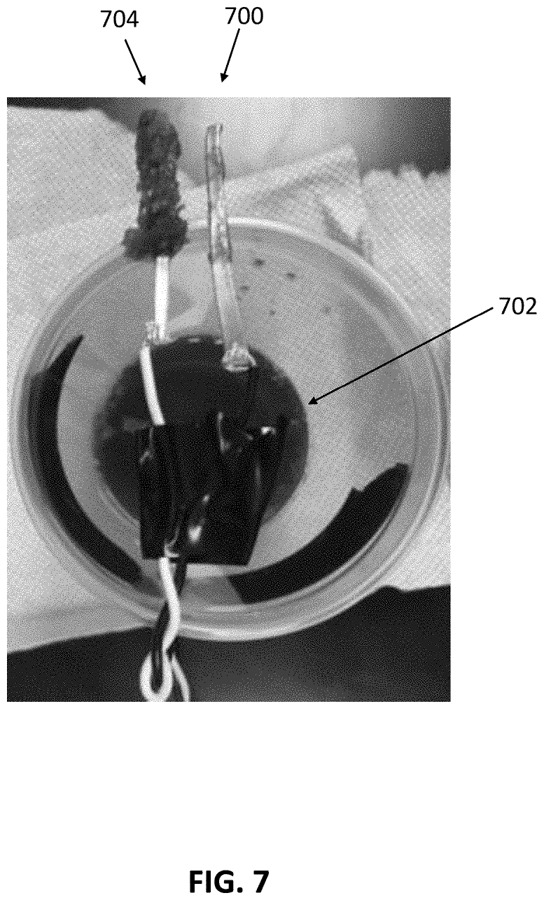

FIG. 7 shows an example charged wire test result of charged connectors 700, e.g., aluminum connectors, immersed in a conventional/traditional heat transfer fluid of high solid content 702, e.g., formulation shown in Table 2. In contrast to the result shown in FIG. 6, there are significantly more corrosion/salt deposits 704 on the connectors 700.

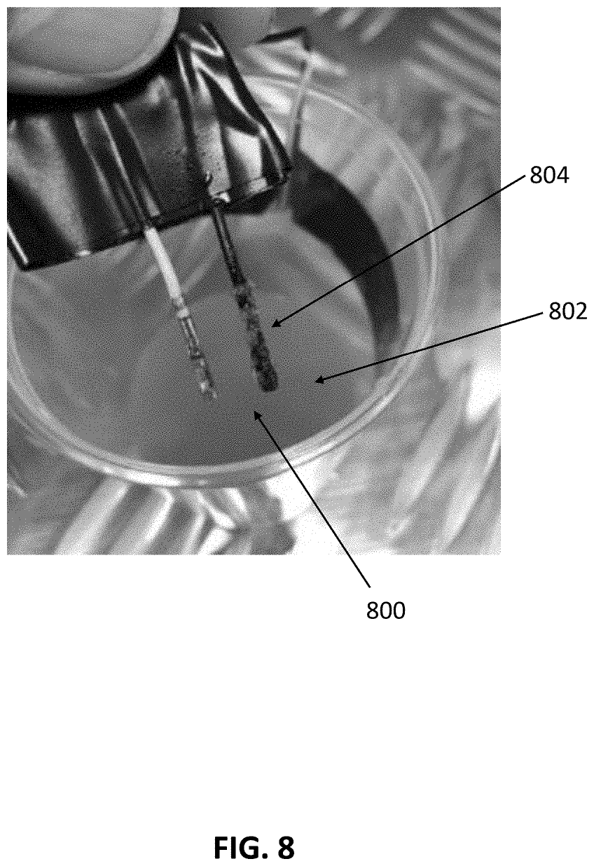

FIG. 8 shows an example charged wire test result of charged connectors 800, e.g., nickel plated brass connectors, immersed in a low solid and low electrical conductivity heat transfer fluid 802 disclosed herein, e.g., formulation shown in Table 5. There are only a small amount of corrosion/salt deposits 804 on the connectors 800.

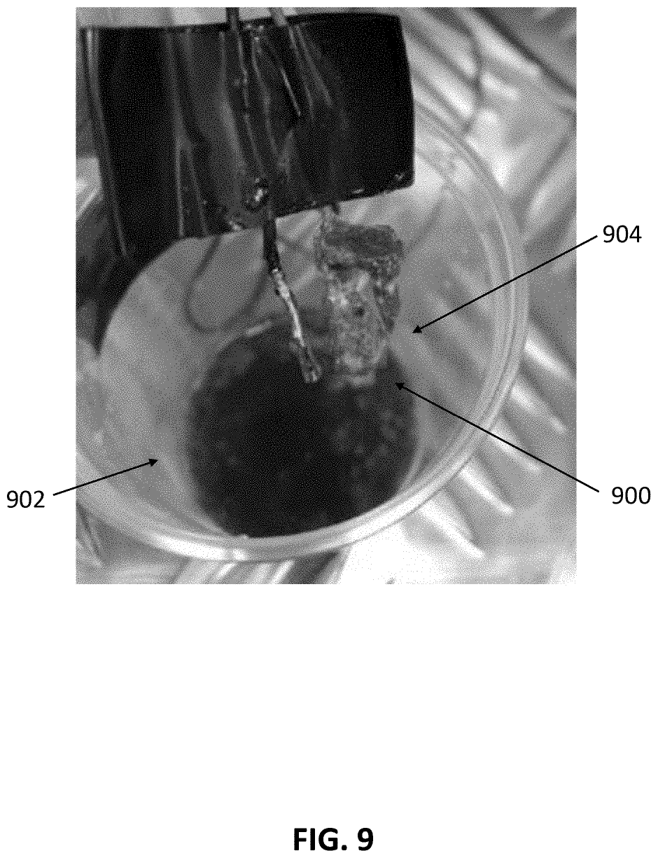

FIG. 9 shows an example charged wire test result of charged connectors 900, e.g., nickel plated brass connectors, immersed in a conventional/traditional heat transfer fluid of high solid content 902, e.g., formulation shown in Table 2. In contrast to the result shown in FIG. 8, there are significantly more corrosion/salt deposits 904 on the connectors 900.

The low solids heat transfer fluids disclosed herein, e.g., formulations shown in Tables 3, 4, and 5, are formulated to meet the stringent requirements for corrosion protection for metal, metal alloy, elastomer, and/or polymer materials and to meet the stringent requirements of low electrical conductivity, e.g., improved safety when the heat transfer fluids are in contact with electrically charged parts. In particular, the low solids heat transfer fluids disclosed herein, e.g., formulations shown in Tables 3, 4, and 5, are formulated for being used in any suitable mobile or stationary energy storage devices or systems, e.g., batteries, rechargeable batteries, lithium ion batteries, fuel cells, capacitors, etc. in automobiles, electric vehicles, electric charging stations, renewable energy applications, power generation/storage applications, etc.

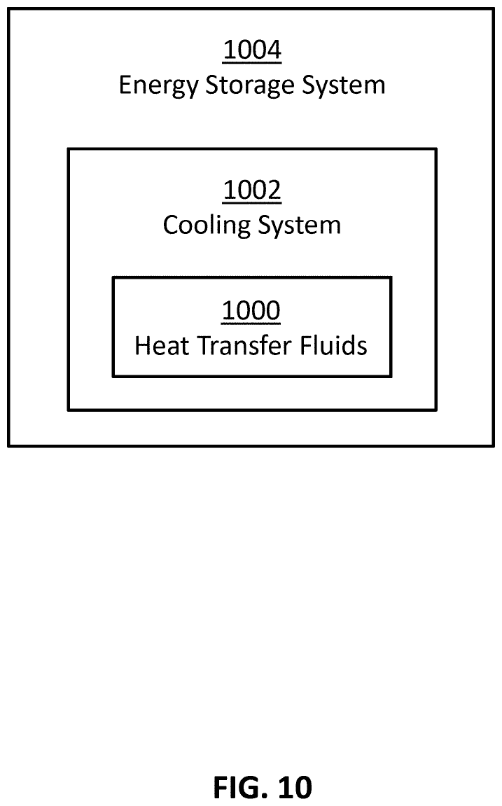

FIG. 10 show an example application of the heat transfer fluids 1000 in a cooling system 1002 of an energy storage system 1004. The heat transfer fluids 1000 include formulations discussed herein, e.g., formulations shown in Tables 3, 4, and 5. The heat transfer fluids 1000 are contained or enclosed in the cooling system 1002 configured to cool components of the energy storage system 1004. The cooling system 1002 may be an indirect cooling system. The energy storage system 1004 may be any mobile or stationary energy storage devices or systems, e.g., batteries, rechargeable batteries, lithium ion batteries, fuel cells, capacitors, etc. in automobiles, electric vehicles, electric charging stations, renewable energy applications, power generation/storage applications, etc. In one example, the cooling system 1002 is an indirect cooling system configured to cool the energy storage system 1004 of an electric vehicle.

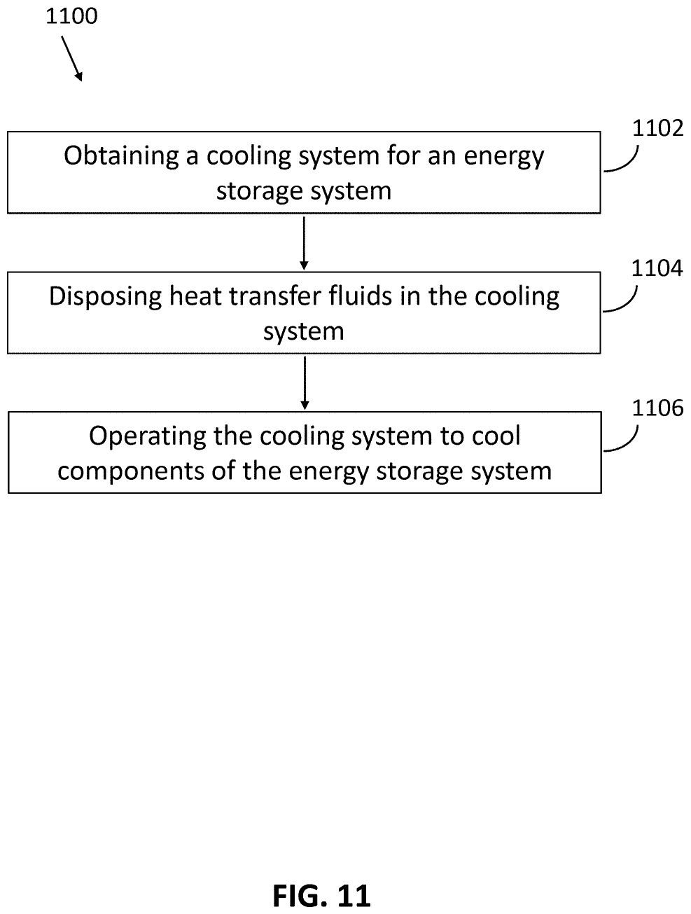

FIG. 11 shows an example method 1100 of cooling an energy storage system. The method 1100 includes obtaining a cooling system for an energy storage system (step 1102). The cooling system may be an indirect cooling system, e.g., the cooling system 1102. The energy storage system, e.g., the energy storage system 1104, may be any mobile or stationary energy storage devices or systems, e.g., batteries, rechargeable batteries, lithium ion batteries, fuel cells, capacitors, etc. in automobiles, electric vehicles, electric charging stations, renewable energy applications, power generation/storage applications, etc.

The method 1100 includes disposing heat transfer fluids in the cooling system (step 1104). The heat transfer fluids include formulations disclosed here, e.g., formulations shown in Tables 3, 4, and 5. The method 1100 includes operating the cooling system to cool components of the energy storage system (step 1106). Step 1106 includes circulating the heat transfer fluids to cool components of the energy storage system during operation of the energy storage system. In one example, the heat transfer fluids, e.g., formulations shown in Tables 3, 4, and 5, are circulated through various components of the battery system, e.g., lithium ion battery system, of an electrical vehicle during operation of the electrical vehicle. The heat transfer fluids are formulated such that even when the heat transfer fluids leak out of the cooling system and contact the sections of electrical systems with exposed terminals or connectors, the leak does not cause short circuits, arcing or ignition of the electrical system.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A heat transfer fluid concentrate for electrical applications comprising:
water soluble glycol 70% by weight (wt. %) to 98 wt. %;
demineralized water 0 wt. % to 30 wt. %; and
a total dissolved solid additive content in the heat transfer fluid concentrate of 0.1 wt. % to 2 wt. %, wherein an electrical conductivity of the heat transfer fluid concentrate is 100 micro-siemens per centimeter (μS/cm) to 5000 μS/cm.

2. The heat transfer fluid of claim 1, wherein the water soluble glycol comprises an antifreeze grade ethylene glycol and the heat transfer fluid further comprises a balance of an azole compound, an alkaline neutralizing agent, and/or liquid organic additives.

3. The heat transfer fluid of claim 1, wherein an alkalinity of the heat transfer fluid is provided by alkali metal hydroxides and/or amines like triethanolamine (TEA).

4. The heat transfer fluid of claim 1, comprising water soluble alcohols.

5. The heat transfer fluid of claim 1, comprising ethylene glycol, propylene glycol, high molecular weight glycols, anhydrous polyglycols, base oil, silicone oil, glycol ethers, or a combination thereof.

6. (canceled)

7. The heat transfer fluid of claim 1, comprising:
liquid organic acids comprising branched hydrocarbon chain structures comprising isononanoic acid, 2-ethylhexanoic acid, or a combination thereof and
liquid amines comprising triethanolamine, related liquid compound, or a combination thereof.

8. The heat transfer fluid of claim 1 is formulated for use in a cooling system of an electrical vehicle.

9-20. (canceled)

21. A heat transfer fluid concentrate for electrical applications comprising:
water soluble glycol 70% by weight (wt. %) to 98 wt. %;
demineralized water 0 wt. % to 30 wt. %; and
a total dissolved solid additive content in the heat transfer fluid concentrate of 0.1 wt. % to 2 wt. %, the solid additive is the sum of alkaline metal hydroxide, azole compound, inorganic acid, and stabilized-silicate present in the heat transfer fluid concentrate, wherein an electrical conductivity of the heat transfer fluid concentrate is 100 micro-siemens per centimeter (μS/cm) to 5000 μS/cm.

22. The heat transfer fluid of claim 21, wherein the water soluble glycol comprises an antifreeze grade ethylene glycol, and the heat transfer fluid further comprises a balance of the azole compound, an alkaline neutralizing agent, and/or liquid organic additives.

23. The heat transfer fluid of claim 21, comprising water soluble alcohols.

24. The heat transfer fluid of claim 21, comprising ethylene glycol, propylene glycol, high molecular weight glycols, anhydrous polyglycols, base oil, silicone oil, glycol ethers, or a combination thereof.

25. The heat transfer fluid of claim 21, comprising:
liquid organic acids comprising branched hydrocarbon chain structures comprising isononanoic acid, 2-ethylhexanoic acid, or a combination thereof; and
liquid amines comprising triethanolamine, related liquid compound, or a combination thereof.

26. The heat transfer fluid of claim 21 is formulated for use in a cooling system of an electrical vehicle.

27. A heat transfer fluid concentrate for electrical applications comprising:
water soluble glycol 70% by weight (wt. %) to 98 wt. %;
demineralized water 0 wt. % to 30 wt. %;
a total dissolved solid additive content in the heat transfer fluid concentrate of 0.1 wt. % to 2 wt. %, wherein the solid additive excludes benzoate and nitrate, and wherein an electrical conductivity of the heat transfer fluid concentrate is 100 micro-siemens per centimeter (μS/cm) to 5000 μS/cm.

28. The heat transfer fluid of claim 27, wherein the water soluble glycol comprises an antifreeze grade ethylene glycol, and the heat transfer fluid further comprises a balance of an azole compound, an alkaline neutralizing agent, and/or liquid organic additives.

29. The heat transfer fluid of claim 27, wherein an alkalinity of the heat transfer fluid is provided by the alkali metal hydroxides and/or amines like triethanolamine (TEA).

30. The heat transfer fluid of claim 27, comprising water soluble alcohols.

31. The heat transfer fluid of claim 27, comprising ethylene glycol, propylene glycol, high molecular weight glycols, anhydrous polyglycols, base oil, silicone oil, glycol ethers, or a combination thereof.

32. The heat transfer fluid of claim 27, comprising:
liquid organic acids comprising branched hydrocarbon chain structures comprising isononanoic acid, 2-ethylhexanoic acid, or a combination thereof and
liquid amines comprising triethanolamine, related liquid compound, or a combination thereof.

33. The heat transfer fluid of claim 27 is formulated for use in a cooling system of an electrical vehicle.
